(19) United States
(12) Patent Application Publication
(10) Pub. No.: US 2026/0331852 A1
(43) Pub. Date: Oct. 22, 2026

(54) Method, Connecting Arrangement and Use of a Connecting Arrangement for at Least Two Stranded Lines

(71) Applicant: FIT Voltaira Autokabel Gruppe GmbH, Pfullingen (DE)

(72) Inventors: Thomas Lorenz, Velbert (DE); Sebastian Martens, Straelen (DE)

(21) Appl. No.: 19/106,816

(22) PCT Filed: Sep. 21, 2023
(86) PCT No.: PCT/EP2023/075998

§ 371 Date: Feb. 26, 2025

(30) Foreign Application Priority Data
Sep. 21, 2022 (DE) 10 2022 124 222.6

(51) Int. Cl. H01R 43/02; H01R 4/62

(52) U.S. Cl. CPC H01R 43/0249; H01R 4/625; H01R 43/0207; H01R 43/0221; H01R 43/0263; H01R 2201/26

(57) ABSTRACT

The invention relates to a method for connecting at least two stranded lines to a busbar, in which method the at least two stranded lines are provided, each stranded line having an end region in which the individual wires of the stranded line are free of insulation, a sleeve is pushed onto each end region, each sleeve is pressed onto the individual wires, each of the connecting regions are placed onto the busbar at two spaced-apart contact regions, the contact regions being on a common first side of the busbar, and, starting from a second side of the busbar opposite the first side, the sleeve, the individual wires and the busbar being welded together at each contact region.

The subject matter relates to a method for connecting at least two stranded lines to a busbar and to a corresponding connection between two stranded lines and a busbar as well as use of such a connecting arrangement.

The connection of a plurality of electrical lines to a potential busbar in a confined space, in particular a material connection, is challenging in terms of the connection technology as well as the quality and durability of the connection. In particular, when connecting aluminum stranded lines to metallic busbars made of aluminum or copper, known connecting methods, e.g. when using laser welding, lead to weakening of the individual wires due to the temperature introduced by the laser around the welding zone, in particular in the longitudinal direction of the individual wires, at a distance from the actual welding zone. Such weakening of the individual wires during connection of the lines to the busbar has disadvantages in terms of the durability of the connection, in particular in dynamic environments. Alternating bending loads can lead to increased strand breakage due to initial damage to the individual wires.

Lines that are connected to a busbar are usually several centimeters to several meters long. Such lines cannot be connected to the busbar by means of rotational friction welding. It is not possible to rotate such long lines during welding. On the other hand, as soon as a second line is arranged on a busbar, the busbar can no longer be rotated around this second line. This means that rotational friction welding is not an option as a connection technology.

Ultrasonic welding is also problematic if a plurality of connections is to be made to a busbar using ultrasonic welding. An existing ultrasonic welding seam is negatively affected, damaged or destroyed by the introduction of ultrasonic vibrations from a subsequent welding process. Therefore, stranded lines on busbars cannot be reliably connected by ultrasonic welding if a plurality of these stranded lines are to be contacted and the welding points are spatially close to one another.

The object of the invention was therefore to provide a welding method that makes it possible to permanently and stably materially connect a plurality of stranded lines to a common busbar.

This object is achieved by a method according to claim 1.

It is proposed to provide at least two stranded lines. Stranded lines are lines having a plurality of individual wires that are not separately insulated from one another. The individual wires can be woven, stranded and/or twisted together. The individual wires are metallic, in particular made of a transition metal. Aluminum or copper as well as aluminum alloys or copper alloys are particularly suitable as materials for the individual wires. The individual wires of the stranded lines can be covered with a common insulation. A combination of the aforementioned materials is also possible.

Each stranded line has two distal ends. One end may have an end region in which the individual wires of the stranded line are free of insulation. To avoid misunderstandings, it should be clarified that a stranded line can also be completely free of insulation. Preferably, the stranded line is part of a cable, the cable being formed at least from the stranded line and the insulation. The insulation is missing in one end region, in particular it has been removed there. An end region can extend from an end face of the stranded line to the center of the stranded line and in particular have a longitudinal extension between 0.5 cm and 5 cm or more. An insulating material can in particular be silicone, PVC, VPE, PTFE, PES, PE or the like.

It is proposed that a sleeve be pushed onto an end region of each stranded line. A sleeve can be pushed onto a stranded line at only one end region or at both distal end regions. Each stranded line that is physically contacted with the busbar has a sleeve pushed onto at least one of its end regions. The sleeve is preferably metallic, in particular made of the same material as the stranded line and/or the busbar. The sleeve can also be made of a different material from the stranded line and/or the busbar. The sleeve may be made of aluminum, copper, an aluminum alloy or a copper alloy.

The sleeve can be pushed from the end of the stranded line over the individual wires of the stranded line. The sleeve is preferably pushed onto the end region in the longitudinal direction of the stranded line. As will be described below, the sleeve can be formed as a one-piece component or as a multi-piece component. The sleeve has a longitudinal opening into which the individual wires of the stranded line are inserted. The sleeve can also be made of a band which is placed circumferentially around the individual wires of the stranded line in the end region and, if necessary, welded.

After the sleeve has been pushed onto the respective end region, it is proposed that the respective sleeve be pressed onto the individual wires. For this purpose, the sleeve is radially compressed (pressed). The sleeve connects to the individual wires in a force-locking and positive-locking manner by compressing the opening of the sleeve radially inwards. When the sleeve is pressed onto the individual wires, the individual wires can be compacted. Preferably, the individual wires are compacted such that a degree of compaction of over 90%, preferably over 95%, in particular over 98% is achieved. A degree of compaction preferably results from the ratio of the metallic cross-sectional area and the cross-sectional area with air inclusion, preferably in a cross section perpendicular to the longitudinal axis of the stranded line.

An individual wire has a cross-sectional area of 4*D_{wire}²/π. The cross-sectional area of all N individual wires is N*4*D_{wire}²/π. The cross-sectional area of the sleeve is the difference between the cross-sectional area at the outer diameter (Dₒᵤₜₑᵣ) of the sleeve (4*Dₒᵤₜₑᵣ²/π) and the cross-sectional area at the inner diameter (Dᵢₙₙₑᵣ) of the sleeve (4*Dᵢₙₙₑᵣ²/π), i.e. (4*Dₒᵤₜₑᵣ²/π)−(4*Dᵢₙₙₑᵣ²/π). The total cross-sectional area of the stranded line with the individual wires and the sleeve, without air inclusions, is (4*D_{wire}²/π)+((4*Dₒᵤₜₑᵣ²/π)−(4*Dᵢₙₙₑᵣ²/π)). This is the cross-sectional area of the metal part of the sleeve, including the individual wires. The cross-sectional area of the pressed sleeve, including wires and any remaining air inclusions, is (4*D_{pressed}²/π).

The degree of compaction is determined from the quotient of the total cross-sectional area and the cross-sectional area of the pressed sleeve, i.e.

$$\frac{( 4 * ( \frac{D w i r {e}^{2}}{π} ) ) + ( ( 4 * \frac{D o u t e {r}^{2}}{𝔫} ) - ( 4 * \frac{D i n n e {r}^{2}}{π} ) )}{( 4 * ( \frac{D p r e s s e {d}^{2}}{π} ) )}$$

In short, the degree of compaction is:

$$\frac{{Dwire}^{2} + D o {uter}^{2} - D i {nner}^{2}}{Dpresse {d}^{2}}$$

Assuming that the sleeve and wires are not axially stretched during pressing, a fully pressed sleeve, without air inclusions, results in a degree of compaction of 1 (100%). It is proposed that the degree of compaction be between 90% and 100%, preferably between 95% and 100%, in particular between 98% and 100%.

However, it is conceivable, and also proposed, that at least the sleeve is axially stretched during pressing. This means that the value Dₒᵤₜₑᵣ²−Dᵢₙₙₑᵣ² is smaller for a pressed sleeve than for the unpressed sleeve. This in turn means that the pressed sleeve has a cross-sectional area that is smaller than the total cross-sectional area in the unpressed state. The degree of compaction is then greater than 100%. It is proposed that by axially stretching the sleeve during pressing, a degree of compaction of greater than 100% is achieved, in particular between 100% and 110%, preferably between 100% and 105%, in particular between 100% and 102%.

After the sleeve has been pressed onto the individual wires, the respective sleeve, preferably together with the individual wires, is cut to length at the end face such that the individual wires and the sleeve substantially form a flat connecting region on the end face of the sleeve. The connecting region preferably lies in a plane perpendicular to the longitudinal axis of the stranded line. The connecting region is preferably planar, formed from the end face of the cut sleeve and the end face of the cut individual wires of the stranded line. Cutting to length is preferably carried out such that all the individual wires of the stranded line are cut to length. All the individual wires that may be protruding from the end face in the longitudinal direction are cut to length so that all the individual wires are in contact with the connecting region on the end face and form a common plane with the end face of the sleeve.

Cutting to length is preferably carried out by laser cutting. However, cutting to length may also be carried out by milling or sawing. Optionally, the end face of the individual wires and the sleeve can also be cut to length by grinding so that the connecting region is formed. It is also possible to carry out cutting to length using a combination of the methods mentioned above.

The sleeve and the individual wires arranged therein are then placed onto the busbar with their connecting regions. As already explained in the introduction, at least two stranded lines and two sleeves are provided. The explanations for each sleeve, including individual wires, naturally apply to all at least two stranded lines with a sleeve. It should be noted that the respective method steps in this document are sometimes only described for one stranded line and/or one sleeve. It should be noted that the method steps preferably apply to all sleeves connected to the busbar, but at least to two sleeves and stranded lines connected to the busbar. In this respect, the term “each” is sometimes used to express that not just one, but a plurality of sleeves and stranded lines with their connecting regions are connected to spaced-apart contact regions of the busbar.

It is proposed that each connecting region is placed onto the busbar at spaced-apart contact regions.

The busbar has a region where the stranded lines are to be attached. In this region, at least two spaced-apart contact regions are provided, which are intended to accommodate the connecting regions of each stranded line. The connecting regions are placed onto the two spaced-apart contact regions. The number of contact regions corresponds to the number of connecting regions, i.e. with two stranded lines there are two contact regions and with N stranded lines there are N contact regions with N∈ [symbol] .

It is proposed that the contact regions are arranged on a common side of the busbar. The connecting regions are placed onto a common side on the contact regions of the busbar. The busbar is preferably formed as a flat part and has two wide surfaces that lie opposite one another. These wide surfaces preferably run parallel to one another. The contact regions preferably lie on a common wide surface. The busbar is preferably metallic, in particular made of the same material as the stranded line and/or the sleeve. The busbar can also be made of a different material from the stranded line and/or the sleeve. The busbar can be made of aluminum, copper, an aluminum alloy or a copper alloy. The connecting regions are placed onto the contact regions.

The sleeve and the individual wires are then welded to the busbar. In this case, it is proposed that, starting from a second side of the busbar opposite the first side, the sleeve, the individual wires and the busbar are welded together at each contact region. This means that the welding is carried out starting from the second side opposite the first side. As will be shown below, various welding processes are suitable for this purpose: on the one hand, in which the sleeve together with the stranded line can be pushed through the busbar and, on the other hand, welding processes in which the welding takes place through the busbar into the stranded line and the sleeve, e.g. friction spot welding.

As the welding is carried out starting from the second side, only a small amount of heat is introduced into the individual wires, in particular in a region away from the welding node. The individual wires extend from the flat connecting region in the longitudinal direction towards the center of the stranded line. The heat input preferably only occurs in the connecting region and only penetrates the individual wires in the longitudinal direction to a small extent.

The sleeve ensures that the mechanical load on the welding seam and the individual wires in the region of the welding seam is reduced under dynamic stress compared to conventional welding methods. By welding starting from the second side and in particular by using the sleeve, strand breakage under dynamic, mechanical loads is largely prevented. The sleeve absorbs the mechanical loads directly next to the weld/heat-affected zone.

According to one exemplary embodiment, it is proposed that the busbar has openings, in particular through-openings, in particular bores, in the contact regions. It should be noted that an opening can form a contact region. The openings preferably run parallel to the surface normal of the surface of the busbar in which the contact region is located. The opening preferably has a diameter that corresponds to the diameter of the pressed sleeve. The opening can be a clearance fit, transition fit or press fit with the sleeve. The sleeve is inserted into the opening. The sleeve is inserted into the opening with its connecting region starting from the first side towards the second side. The sleeve is preferably inserted into the opening such that the connecting region is flush with the surface of the second side of the busbar after insertion or slightly protrudes beyond it (in particular with a tolerance of between 0.2 mm-2.0 mm). According to one exemplary embodiment, it is proposed that the sleeve is inserted through the opening in the busbar such that the sleeve and the individual wires with their connecting regions (after insertion) lie approximately in the same plane as the surface of the second side.

According to one exemplary embodiment, it is proposed that the busbar, the sleeve and the individual wires are welded together starting from the second side by means of a laser.

When welding the sleeve, the individual wires and the busbar, the individual wires are in particular welded together. The end faces of the individual wires can be welded together using a laser, so that the resulting welding node extends only a few 1/10 millimeters to a few millimeters into the stranded line. This reduces the thermal load on the individual wires. In particular, the welding node extends into the stranded line only according to the distance from the first to the second side of the busbar.

The sleeve can also be welded to the individual wires. In particular, an inner side surface of the opening of the sleeve is welded to the individual wires. In particular, the individual wires that are attached to the outside of the sleeve are welded to the inner surface of the opening of the sleeve.

The sleeve can also be welded to the busbar. In this case, the opening of the busbar is welded to the sleeve. In particular, an outer surface of the sleeve is welded to an inner surface of the opening of the busbar. The welding can be such that a uniform welding node is formed from the individual wires, the sleeve and the busbar. A uniform welding node is formed across the individual wires, the sleeve and the busbar. This uniform welding node seals any gaps between the individual wires, between the individual wires and the sleeve as well as between the sleeve and the busbar, preferably completely, so that moisture can no longer penetrate through this welding node in the longitudinal direction along the sleeve and the individual wires into the stranded line.

Preferably, the welding node is located only at the end face of the individual wires and the sleeve and in particular exclusively within the busbar. This means that the welding node spreads in the longitudinal direction of the stranded line preferably to a maximum extent corresponding to the material thickness of the busbar. The busbar and its material thickness ensure that the individual wires are preferably only exposed to heat input in the region of the busbar, which leads to an influence on the material. The individual wires that lie in the sleeve outside the busbar on the first side are not or only slightly affected by the welding. The connection between the busbar, the sleeve and the strand is therefore permanently stable and considerably less sensitive to alternating bending loads than conventional welds.

According to one exemplary embodiment, it is proposed that each sleeve is placed with its connecting region onto the contact region of the first side of the busbar. Unlike the previously described exemplary embodiments, the busbar has no openings to accommodate the sleeves and the individual wires. The sleeves and the individual wires are placed with their flat connecting regions directly onto the contact region on the first side.

Welding then takes place starting from the second side. Laser welding can be used here; however, friction spot welding is preferred. It is proposed that the sleeve with its connecting region is placed onto the contact region of the first side of the busbar such that the sleeve and the individual wires with their connecting regions lie substantially in the same plane as the first side. It is preferred that the sleeve together with the individual lines with its connecting region is pressed with a contact force against the contact region of the first side. This contact force is preferably greater than the force that a friction spot welding tool exerts on the sleeve and the strand from the first side.

The sleeve pressed against the first side together with the individual wires is then welded to the busbar. It is proposed that the busbar, the sleeve and the individual wires are welded together starting from the second side by means of a friction spot welding process.

Preferably, a friction tool, preferably consisting of at least three parts, is first placed on the second side. The friction tool is preferably placed concentrically to the sleeve to be welded on the second side. The friction tool comprises a punch, a sleeve guided in the punch and a pin arranged in the sleeve. In friction spot welding, the punch and sleeve are placed onto the second side. The pin is then placed onto the second side in a rotating manner within the sleeve. As the pin rotates, frictional energy is introduced into the busbar in the region of the pin's contact surface and the material of the busbar melts. In the further course of the process, sufficient frictional energy is introduced into the busbar such that the busbar melts in the contact region, in particular over its entire material thickness, and in particular up to the first side and the sleeve and individual wires resting there. Subsequently, the sleeve on the first side and the individual wires in the connecting region will also be melted. During this melting, the sleeve of the welding tool, which is guided within the punch, is preferably moved from the second side towards the first side, so that the melted material of the busbar, the individual wires and the sleeve are mixed together and in particular are mixed together through the busbar.

The pin is then pulled out of the sleeve of the welding tool while continuing to rotate, while the sleeve is moved towards the second side, the busbar. This allows a point connection between the busbar, the sleeve and the individual wires without creating a hole. After the melted materials have cooled, the punch and sleeve of the welding tool as well as the pin of the welding tool are lifted off the second side and a uniform welding node is formed which extends through the busbar into the sleeve and the individual wires.

In an alternative friction spot welding, the punch and the sleeve are placed onto the second side. The sleeve is then placed onto the second side in a rotating manner. By rotating the sleeve, frictional energy is introduced into the busbar in the region of the pin's contact surface and the material of the busbar melts. In the further course of the process, sufficient frictional energy is introduced into the busbar such that the busbar melts in the contact region, in particular over its entire material thickness, and in particular up to the first side and the sleeve and the individual wires resting there. Subsequently, the sleeve on the first side and the individual wires in the connecting region will also be melted. During this melting, the pin of the welding tool, which is guided within the sleeve, is preferably moved from the second side towards the first side, so that the melted material of the busbar, the individual wires and the sleeve are mixed together and in particular are mixed together through the busbar.

The sleeve is then pulled out of the weld metal while continuing to rotate, while the pin is moved towards the second side, the busbar. This allows a point connection between the busbar, the sleeve and the individual wires without creating a hole. After the melted materials have cooled, the punch and sleeve of the welding tool as well as the pin of the welding tool are lifted off the second side and a uniform welding node is formed which extends through the busbar into the sleeve and the individual wires.

It is preferred if the individual wires are welded together. The rotating pin preferably melts all the individual wires on the end face and a uniform welding node is formed over preferably all the individual wires. It is also preferred if the individual wires are welded to the sleeve. The rotating pin preferably melts the individual wires and the sleeve on the end face and a uniform welding node is formed preferably over the individual wires and the sleeve. In particular, the outer circumferential individual wires of the stranded line are welded to the inner surface of the sleeve. It is also preferred if the sleeve is welded to the busbar. The rotating pin preferably melts the sleeve and the busbar and a uniform welding node is formed preferably over the sleeve and the busbar. It is preferred if the end face of the sleeve is welded to the busbar on the first side. It is also preferred if the individual wires are welded to the busbar. The rotating pin preferably melts the individual wires and the busbar and a uniform welding node is formed over the individual wires and the busbar. It is preferred if the end faces of the individual wires are welded to the busbar on the first side. A uniform, continuous welding node over the busbar, the sleeve and the individual wires is preferred. Preferably, this welding node completely closes a gap between the end face of the sleeve and the first side of the busbar. The welding node extends through the busbar into the sleeve and the individual wires that rest on the contact surface on the first side.

As previously explained, it is preferred that the busbar is formed as a flat part. The busbar can be formed from a sheet metal or a strip. In particular, the busbar can be cut or punched from a sheet metal or a strip. The busbar can be designed such that the contact region(s) are part of a projecting tab. The busbar can have at least one, preferably two opposing tabs or four opposing tabs in pairs. The tabs project outwards from one side edge of the flat part of the busbar. The tabs can project from opposite side edges of the busbar. Preferably, a tab can also project on each or more than two side edges of the busbar. The busbar can initially be provided as a flat part and the stranded line including the sleeve can be materially connected to the busbar in the manner described above.

To realize certain connection geometries, it can be useful if the longitudinal axes of the stranded lines run at an angle to the surface normal of the flat part. In particular, it may be useful if the stranded lines run in a plane to the busbar that is parallel to the plane of the first and/or second side of the busbar. For this reason, it may be useful to bend the respective tabs around the side edge after welding the busbar in the respective contact regions with the respective sleeve and the individual wires. A bend of more than 45°, in particular between 45 and 135°, in particular 90°, can be useful.

When bent by 90°, the plane in which the two longitudinal axes of the stranded lines lie is substantially parallel to the plane of the first and/or second side.

A further aspect is a connecting arrangement according to claim 11. This connecting arrangement has the advantage that stranded lines are arranged on a busbar without significant structural damage and are thus permanently, stably attached even under dynamic loads.

According to one exemplary embodiment, it is proposed that the individual wires of the stranded line are made of aluminum or aluminum alloys. In particular, AL99.5 or Al99.7 as well as annealed aluminum can be advantageous.

The material of the busbar can be the same as the material of the stranded line and/or the sleeve and can in particular be aluminum or an aluminum alloy, or copper or a copper alloy. It is also possible that the material of the busbar is different from the material of the individual wires. It is also possible that the material of the busbar is different from the material of the sleeve.

As already explained, the end region of the stranded lines is inserted into the sleeve. For this reason, it is proposed that the sleeve has a longitudinal through-opening. It is also possible for the sleeve to have a longitudinal blind hole. The individual wires of the stranded line are inserted into the opening. The sleeve may have a base on one end face, wherein the base may have an opening or taper that has a different cross section from the opening into which the individual wires are inserted. In particular, a cross section of the base opening or taper is advantageous in which regions extending radially further outwards alternate with regions extending radially less outwards. Non-circular outline shapes of the opening/taper are preferred, whereby, for example, a multiple axial symmetry is possible. In the simplest case, this is a threefold axial symmetry. One possible particularly preferred embodiment provides that the outline shape of the opening/taper is approximately similar to an epicycloid. The opening/taper could also have an angular outline shape, for example a polygon outline. Combinations of angular and cycloidal outline shapes could also be chosen.

Such a design of the base has several advantages. Firstly, the presence of the base ensures that the individual wires are inserted into the sleeve to a defined depth and are not pushed too far through the sleeve's through-hole. The base thus forms a natural stop for the strands. On the other hand, the taper/opening in the base allows radial pressing of the sleeve so that the individual wires and the sleeve can be pressed together.

As also explained at the outset, the sleeve can be shaped as a tube. The sleeve can also be shaped from a sheet metal. In particular, the sleeve can be formed as a sheet metal folded over the individual wires. The sleeve can be formed in one piece or in multiple pieces.

A further aspect is the use according to claim 15. Considerable mechanical loads occur in particular in motor vehicles, watercraft, aircraft, launch vehicles, spacecraft and satellites. Reliability is of crucial importance, particularly in the case of launch vehicles or spacecraft. The connection in question is particularly suitable for this purpose, as it provides a permanently stable connection even under the highest mechanical loads due to the lack of or only minimal impairment of the individual wires during the connection process.

The subject matter is explained in more detail below with reference to drawings showing exemplary embodiments. In the drawings:

FIG. 1a, b show a stranded line according to one exemplary embodiment;

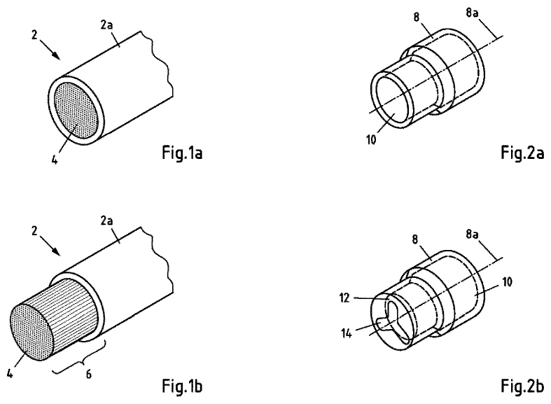

FIG. 2a, b show sleeves according to exemplary embodiments;

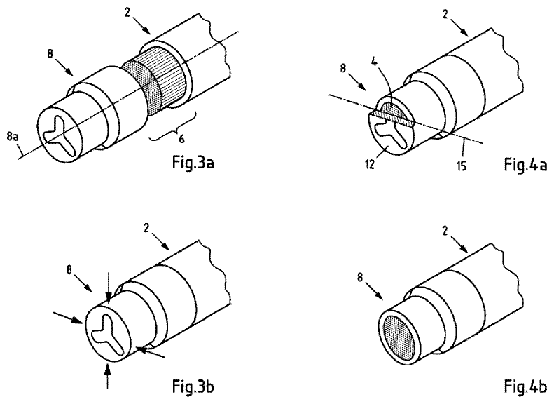

FIG. 3a, b show the placing of a sleeve onto a stranded line according to one exemplary embodiment;

FIG. 4 shows the cutting to length of a sleeve on a stranded line according to one exemplary embodiment;

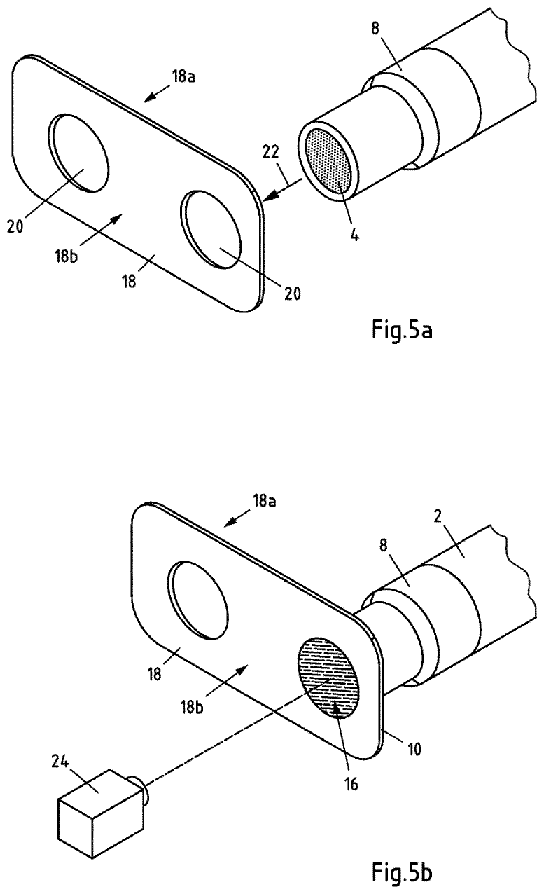

FIG. 5a shows a busbar according to one exemplary embodiment;

FIG. 5b shows a connection between a busbar and a stranded line according to one exemplary embodiment;

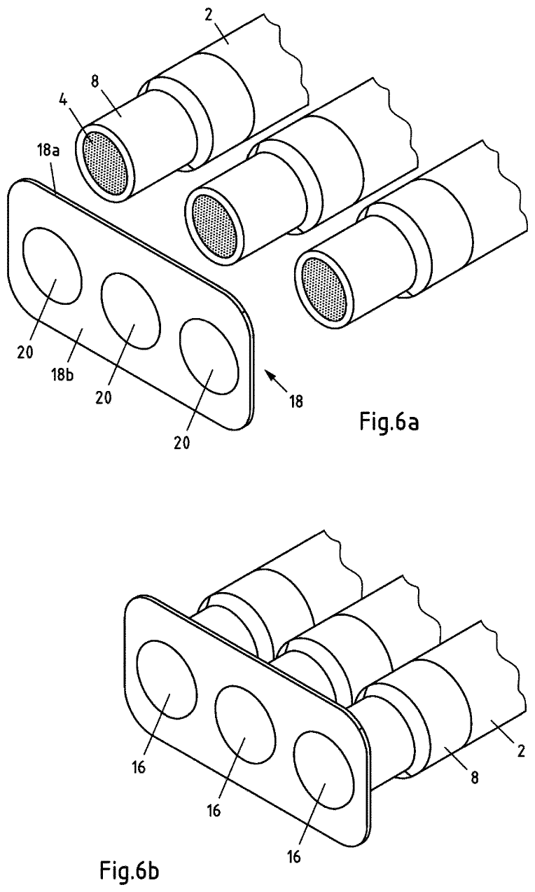

FIG. 6a shows a busbar according to one exemplary embodiment;

FIG. 6b shows a connection between a busbar and a stranded line according to one exemplary embodiment;

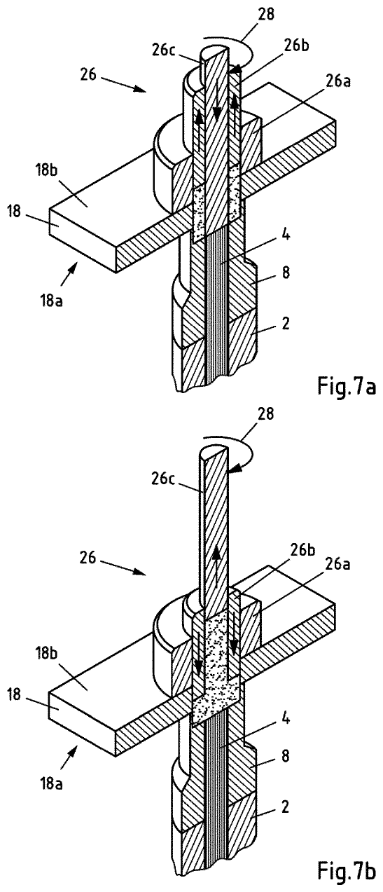

FIG. 7a, b show a friction spot welding process according to one exemplary embodiment;

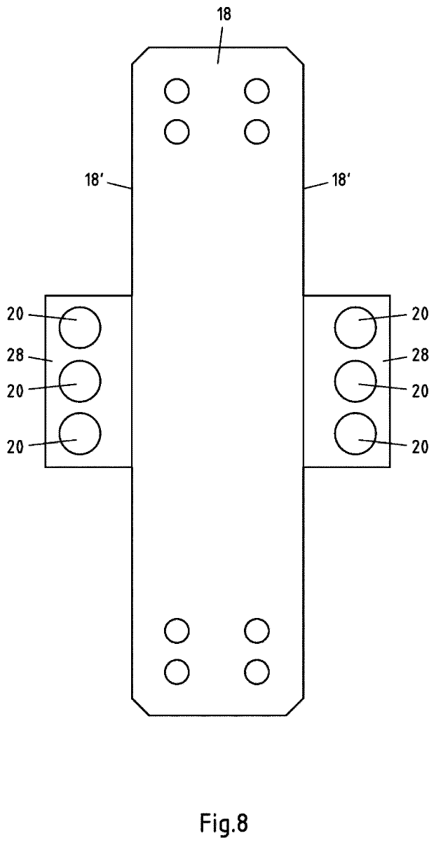

FIG. 8 shows a busbar with projecting tabs according to one exemplary embodiment;

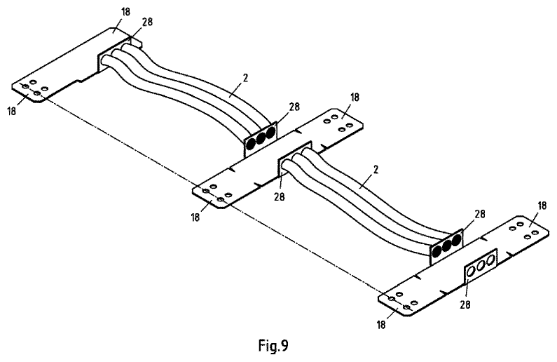

FIG. 9 shows a connecting arrangement with a plurality of busbars and a plurality of stranded lines according to one exemplary embodiment.

FIG. 1a shows an end face of a cable 2. It can be seen that the cable 2 has insulation 2a. The cable 2 has an electrically conductive core that is formed as a stranded line 4.

FIG. 1b shows the end face of the cable 2 in a stripped state. In an end region 6, the insulation 2a is removed and the individual wires of the stranded line 4 are bare.

Such a cable 2 is provided for subsequent processing. It is understood that instead of the cable 2, only the stranded line 4 without insulation 2a may be provided. The end region 6 extends from the end face of the stranded line 4 in the longitudinal direction of the stranded line 4.

A sleeve 8, as shown by way of example in FIG. 2a, b, is pushed onto such an end region 6.

FIG. 2a shows a sleeve 8 extending in a longitudinal direction 8a. Along the longitudinal direction 8a, the sleeve 8 has an opening 10 formed as a through-opening. The sleeve 8 can have a radial offset so that a first region can be pushed onto the insulation 2a and a second region onto the bare individual wires of the stranded line 4. The sleeve 8 of FIG. 2a is free of a base and the opening 10 is continuous.

FIG. 2b shows a sleeve 8 with a base 12. The base 12 closes the opening 10 in an end region of the sleeve 8. An opening 14 can be provided in the base 12. The opening 14 can have regions that project radially further outwards and regions that project radially less far outwards. The opening 14 allows easy pressing in the radial direction of the sleeve 8. Without the opening 14, the base 12 would offer considerable resistance to radial pressing, which may not be desired.

FIG. 3a shows the sleeve 8 being pushed along the longitudinal direction 8a onto the cable 2 or the end region 6.

After the sleeve 8 has been pushed onto the cable 2, it is preferably compressed radially inwards in the end region 6, as indicated by arrows in FIG. 3b. This presses the sleeve 8 with the individual wires of the stranded line 4.

The pressed sleeve 8 with the stranded line 4 is shown in FIG. 4a. After pressing, the base 12 of the sleeve 8 is removed. This can be done, for example, by machining through grinding or milling or without machining through cutting, laser cutting or the like. FIG. 4a shows that the separating plane 15 runs perpendicular to the longitudinal axis 8a. The end faces of the sleeve 8 and the stranded line 4 are exposed along the separating plane 15, as shown in FIG. 4b. The end faces are preferably plane-parallel to one another.

A stranded line 4 prepared in this way is then used to produce a connecting arrangement. FIG. 5a shows an example of a busbar 18 that is formed as a flat part. The busbar 18 has a first side 18a and a second side 18b. The sides 18a, 18 are on opposite sides of the busbar 18. The sides 18a, b are preferably parallel to one another on wide surfaces of the busbar 18.

The busbar 18 has at least two spaced-apart contact regions 20. The contact regions according to FIG. 5a have through-openings through which the sleeve 8 together with the stranded line 4 is inserted. The sleeve 8 together with the stranded line 4 is pushed in the insertion direction 22 from the first side 18a towards the second side 18b through the through-opening in the contact region 20.

After insertion, the end face of sleeve 8 and the stranded line 4 is preferably plane-parallel to the side 18b. The sleeve 8 together with the stranded line 4 is fixed in this position relative to the busbar 18. A laser 24 is then used to form a welding node 16 which extends over the busbar 18, the end face of the sleeve 8 and the end face of the stranded line 4. A uniform welding node 16 is formed which extends over the surface of the stranded line 4, the sleeve 8 and a region of the busbar 18 adjacent to the contact region and has a depth extension which preferably reaches the material thickness of the busbar 18 in the longitudinal direction 8a.

The busbar 18 can have more than two contact regions 20, via which a connection can be formed with the stranded line 4 and the sleeve 8 in the manner shown.

FIG. 6a shows a further exemplary embodiment in which the busbar 18 has a plurality of contact regions 20. In contrast to FIG. 5a, however, the contact regions 20 are not through-openings. Rather, it is proposed, starting from the first side 18a, to press the end faces of the sleeve 8 together with the stranded line 4 against the busbar 8. The sleeve 8 and the stranded line 4 do not penetrate the busbar 18. Friction spot welding is then carried out starting from the second side 18b so that welding nodes 16 are formed, as shown in FIG. 6b.

During friction spot welding, the busbar 18 is melted starting from the second side 18b in the direction of the first side 18a. This process is continued until the end face of the sleeve 8 and the end face of the stranded line 4, which rest on the first side, are also melted, so that the material of the busbar 18, the material of the sleeve 8 and the material of the stranded line 4 can be combined to form a single welding node 16.

Such friction spot welding is shown schematically in FIGS. 7a and b. In FIG. 7a it can be seen that the sleeve 8 together with the stranded line 4 are pressed with their end faces against the first side 18. A friction spot welding tool 26 is then placed onto the second side 18b. In this case, a punch 26a is placed in the contact region 20 on the second side 18b.

A sleeve 26b and a bolt/pin 26c are movably arranged within the punch 26a. For friction spot welding, the bolt 26c is rotated in the direction of rotation 28 and pressed against the material of the busbar 18, starting from the second side 18b.

By rotating the bolt 26c, the material of the busbar 18 is first melted. The bolt is driven further in the direction of the stranded line 4 into the material of the busbar 18 until it also at least partially melts the material of the stranded line 43 and the sleeve 8.

The sleeve 26b is moved away from the busbar 18 in the opposite direction, thereby generating a negative pressure so that the melted material is mixed.

Finally, as shown in FIG. 7b, the bolt 26c is moved away from the first side 18b, transporting the melted material to the second side. At the same time, the sleeve 26b is moved in the direction of the stranded line 4. This counter-movement mixes the melted material and creates a uniform welding node.

Preferably, the bolt 26b is raised to such an extent that its end face remains in the plane of the second side 18b, so that, after raising, the welding node 16 is plane-parallel to the second plane 18b.

FIG. 8 shows a busbar 18 which has tabs 28 on two longitudinal edges 18′. The tabs 28 project outwards from the longitudinal edge 18′. The tabs 28 can be bent around the longitudinal edge 18′ along the longitudinal edge 18′ so that a U- or Z-shaped profile of the busbar 18 is formed in section. The contact regions 20 are provided on the tabs 28. It is preferred that the stranded line 4 together with the sleeve 8 are arranged on the contact regions 20 in the manner described above and that the tabs 28 are then bent around the longitudinal edges 18′.

FIG. 9 shows a configured connecting arrangement in which, starting from a central busbar 18, three cables 2 are arranged on mutually opposite tabs 28 and run in opposite directions. The cables 2 are connected at their respective other distal ends to further tabs 28 on busbars 18 in the manner described.

Using the method shown, it is possible to provide permanently stable connections between stranded lines and busbars.

1-17. (canceled)

18. A method for connecting at least two stranded lines to a busbar, in which
the at least two stranded lines are provided, each stranded line having an end region in which the individual wires of the stranded line are free of insulation,
a sleeve is pushed onto each end region,
each sleeve is pressed onto the individual wires,
each of the connecting regions are placed onto the busbar at two spaced-apart contact regions, wherein the busbar has through-openings in the two contact regions, into which each sleeve is inserted with its connecting region starting from the first side towards the second side, the contact regions being on a common first side of the busbar and the sleeve is inserted through the opening into the busbar such that the sleeve and the individual wires with their connecting regions lie approximately in the same plane as the second side and,
starting from the second side of the busbar opposite the first side, the sleeve, the individual wires and the busbar are welded together at each contact region.

19. The method according to claim 18, wherein the busbar has bores in the two contact regions, into which each sleeve is inserted with its connecting region starting from the first side towards the second side.

20. The method according to claim 18, wherein the busbar, the sleeve and the individual wires are welded together starting from the second side by means of a laser, in particular in that the individual wires are welded to the sleeve, in particular an inner surface of the sleeve, and the sleeve is welded to the busbar, in particular an inner surface of the opening.

21. The method according to claim 18, wherein the busbar, the sleeve and the individual wires are welded together starting from the second side by means of a friction spot welding process, in particular in that the individual wires are welded to the sleeve, in particular an inner surface of the sleeve, and the sleeve is welded to the busbar.

22. The method according to claim 18, wherein the busbar is formed as a flat part, the contact regions being part of a tab of the flat part projecting from a longitudinal edge.

23. The method according to claim 22, wherein after welding the busbar to the sleeve and the individual wires, the tab is bent around the longitudinal edge, in particular by more than 45°.

24. The method according to claim 18, wherein each sleeve is cut to length at the end such that the individual wires and the sleeve substantially form a flat connecting region at the end face of the sleeve.

25. The method according to claim 22, wherein a tab is arranged on each of two opposite longitudinal edges and at least two stranded lines are welded to each tab.

26. A connecting arrangement between at least two stranded lines and a busbar, produced by a method according to claim 18.

27. The connecting arrangement according to claim 26, wherein
the individual wires of the stranded line are made of aluminum or aluminum alloys and/or
the busbar is made of aluminum or aluminum alloys and/or
the sleeve is made of aluminum or aluminum alloys.

28. The connecting arrangement according to claim 26, wherein the sleeve has a longitudinal through-opening or a longitudinal blind hole into which the individual wires of the stranded line are inserted.

29. The connecting arrangement according to claim 26, wherein the sleeve is formed from a tube or a sheet metal.

30. The connecting arrangement according to claim 26, wherein the at least two stranded lines are each welded to a busbar at their distal ends.

31. Use of a connecting arrangement according to claim 26 in a motor vehicle, watercraft, aircraft or launch vehicle, spacecraft or satellite.
